(19) United States
(12) Patent Application Publication
(10) Pub. No.: US 2001/0037217 A1
(43) Pub. Date: Nov. 1, 2001

(54) Method to determine insulin dosage requirements via a diabetic management internet web site which is also telephony accessible including extensions to general diet management

(76) Inventors: Daniel Abensour, Coral Springs, FL (US); Roger Goldwyn, Boca Raton, FL (US)

Correspondence Address: FRANK L. KUBLER, 13261 S. W. 54th Court, Miramar, FL, 33027, US

(21) Appl. No.: 09/812,976

(22) Filed: Mar. 20, 2001

Related U.S. Application Data
(60) Provisional application No. 60/190,882, filed on Mar. 21, 2000.

(51) Int. Cl. G06F 17/60

(52) U.S. Cl. 705/2

(57) ABSTRACT

A computer system for ongoing monitoring and providing medication dosage recommendation to diabetic patients includes: a database for storing patient data; patient database access including one of web access, touch tone telephone access and speech recognition access; a server; a first set of programs contained within the server for processing the patient data and interfacing the data base accesses; a computer terminal connected to the server through the World Wide Web containing the set of programs including the specific interface to the system for a patient's physician to enter patient specific parameters relevant to compute one of the insulin and other medication dosage; a second set of programs contained within the server for diabetic management for interface by a patient and the patient physician by the patient means of database access; and the second set of programs to be used to enter the current blood glucose, the planned intake of carbohydrates, and to generate a recommendation of one of a dosage of diabetic medication and a quantity of glucose for intake.

This application continues from provisional application Ser. No. 60/190,882 filed on Mar. 21, 2000.

### BACKGROUND OF THE INVENTION

1. Field of Invention

The present invention relates to the use of a web-based system to determine and recommend insulin dosage for a specific patient suffering from type 1 diabetes. This system is also accessible via touch-tone telephone and/or speech recognition and exploits speaker verification over the telephone. The invention permits a person who wishes to determine a proper dosage for insulin to either access an Internet site either through traditional access with a device (PC, PDA, etc.) connected to the World Wide Web, here and after referred to as the web or through a telephone, in either case the patient will be authenticated and the system will recommend an insulin dosage. The system will check the validity of the information provided by the patient (blood test results, anticipated carbohydrate intake) and, if required, will provide screen alarms or voice alarms or connection to an on-call physician or physician assistant.

The present invention also telephony enables this web application. In the “telephony” mode, secure access is granted via a userid and a password as well as a mode where a “voiceprint” is matched to authenticate a person. Blood test results and anticipated carbohydrate intake for a meal can be entered either via touch-tone or via speech recognition and relayed via a web interface to the analysis program when the user is accessing the system through a telephone, or via traditional menu based user interface when the user is directly accessing the system through the Internet. The program responds via recorded speech or text-to-speech with the proper dosage of insulin according to parameters entered by the patient's physician or by showing the recommended amount on the screen. Alerts specified by the user or the user's physician are also made available and are communicated to the user. This invention is also applicable to the more general case of diet management.

2. Background and Description of the Prior Art

Web applications that are receiving considerable attention are those related to health. Many of these health sites give reference material for users. Some physicians and clinics have on-line services to interact with patients. Many familiar applications are accessed today via the telephone and use the touch-tone keypad. Such applications included but are certainly not limited to access of ones banking information, access of airline flight information, calls to a “store” to request information, calls to a pharmacy to refill a prescription, etc. In fact, we are all familiar with the constant listing of menus that prompt us for the data we input via the touch-tone keypad. Some of these applications are now being implemented using speech recognition instead of the touch-tone. These provide a more natural means of interaction and allow one to state the request (such as the airline city) instead of entering some numeric code. All of the above applications are also available today with web interfaces and often supply even greater functionality.

User authentication over the telephone or via the web is often with a userid coupled with a password. Employing speech permits one to utilize speaker verification (authentication) which in essence matches a voiceprint of the particular user against one on file. This methodology has been around for a number of years.

A recent article related to this invention appeared in Diabetes Care, Volume 21, Number Apr. 4, 1998. It is titled “An Electronic Case Manager for Diabetes Control” and used an interactive voice response system to capture daily glucose measurements that is exclusively touch-tone driven. Our patent differs in that we envisage glycemic management throughout the day, we are Internet based, and we also incorporate speech recognition for convenient user interaction. No medical application is today taking advantage of these technologies. Our invention has for major objectives the following:

Offering of choices of easy access to the system for patients including those who are not computer literate

Offering specific recommendations tailored to the individual requirements of the patient as determined by his/her physician

Offering easy customization by the physician of patient treatment based on the personal parameters of the patient.

### BRIEF DESCRIPTION OF THE DRAWINGS

Various other objects, advantages, and features of the invention will become apparent to those skilled in the art from the following discussions taken in conjunction with the following drawings, in which:

FIG. 1 is a schematic representation of the flow chart of the inventive system and method, showing the essential elements and their interrelation with an explicit description of selected access interfaces.

FIG. 2 shows an example of the output generated by the method for an example patient in which patient data and recommendations are shown.

FIG. 3 shows weekly statistics and trends generated by the invention and provide a basis for the physician to modify any relevant parameters.

FIG. 4 shows the panel used by the invention to customize the treatment by the physician for the patient.

### SUMMARY OF THE INVENTION

The present invention accomplishes the above-stated objectives, as well as others, as may be determined by a fair reading and interpretation of the entire specification.

This invention has four major parts:

1. The voice interface method

2. The web interface method

3. A method for processing the collected information:

a. The patient identification and the access security mechanisms.

b. Time and values of the blood glucose tests (before breakfast, 2 hours after breakfast, before lunch, 2 hours after lunch, before dinner, 2 hours after dinner, bedtime as well as additional tests as required)

c. Carbohydrates equivalent amount to be ingested. Note that in some cases when a hypoglycemia is detected the system may recommend a minimum amount of carbohydrates to be taken by the patient. In the speech recognition mode, the specific food and the amount could be spoken. For example, one could say “1 cup of mashed potato” or “½ cup of white rice and ⅓ cup of black beans” as well as information directly taken from a food container, i.e. “yogurt with 15 g of carbohydrates” or “yogurt with 15 g of carbs.” The system recognizes abbreviations and also selects the relevant information. In the previous example this will be: 15 g of carbohydrates. When imprecise information is entered, the system will ask questions to the patient, for example if the patient enters a specific meal without specifying the amount, the system will ask “one cup? ½ cup?. . . ”The patient's physician (or the Diabetes Nurse Educator) may enter meal plans as part of the patient personal parameters and their carbohydrates equivalent (as well as other key equivalent numbers such as cholesterol, fat, etc.) Based on the patient input, warnings and even alarms can be issued if the numbers are outside the permitted range.

d. Recommended insulin dosage. This amount is generated by algorithms using various inputs such as patient characteristics, time of the day, amount of carbohydrates and other parameters defined by the physician.

e. Personal notes inputted by the patient, such as and activity levels (1-hour bike exercise for example), having a cold on such day, having flu shot as well as stress level if any, and medication taken.

f. The display and the storage of history, statistical data, graphs and trends.

4. A method for a database organized on a patient records basis and containing all the patient parameters and characteristics. Characteristics cover things like utilization of traditional insulin injections, the type of insulin and insulin mix and corresponding percentages as well as utilization of insulin pump and the associated basal rates. The database method will also allow the containment of all the inputs issued by the patient, such as test results, time, carbohydrates and notes as well as the suggested insulin and carbohydrates amounts.

Virtually all of the specific concepts in speech recognition, speaker verification, interaction of databases and telephony are known. We are patenting the union of a number of relevant technologies to produce an overall novel method.

### DETAILED DESCRIPTION OF THE PREFERRED EMBODIMENTS

As required, detailed embodiments of the present invention are disclosed herein; however, it is to be understood that the disclosed embodiments are merely exemplary of the invention which ay be embodied in various forms. Therefore, specific structural and functional details disclosed herein are not to be interpreted as limiting, but merely as a basis for the claims and as a representative basis for teaching one skilled in the art to variously employ the present invention in virtually any appropriate detailed structure.

Reference is now made to the drawings, wherein like characteristics and features of the present invention shown in the various FIGURES are designated by the same reference numerals.

Preferred Embodiment

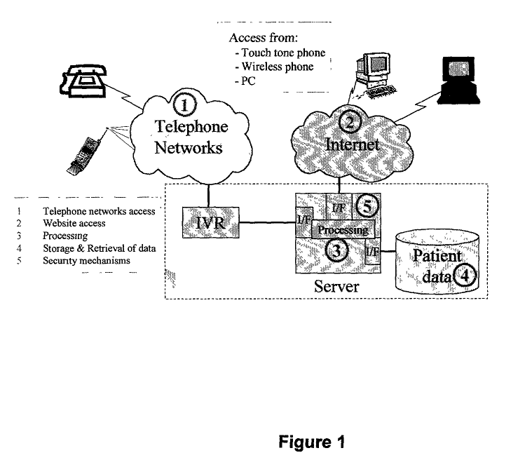

FIG. 1 shows the various components of the system described above. The IVR (Interactive Voice Response) is interfacing the telephone networks. It performs all of the voice input and speech recognition functions. It may be co-located with the processor interfacing the Internet or could be at a remote site with guaranteed bandwidth access to the server.

A patient who wants to monitor and control his insulin is given a specific userid and a password. With this userid, is the telephone number(s) where he can be reached or from which he will call. The user also has recorded over the telephone a listing of names for voiceprints that will be used for speaker verification. When the user calls into the site, the callerid of his phone is recognized and matched against the database of users. If there is a match, then the user is prompted to say a specific phases for speaker verification. This feature is optional. If there is a match, then the user can enter the amount of carbohydrates that he will be eating at his meal as well as the most relevant blood glucose measurements. Entry of the specific carbohydrate food and the amount can all be “spoken” in the speech recognition mode. For example, one could say “half-cup of rice”. All of the entry will be with speech recognition with matching on keywords. If the user calls from a telephone that is not on the pre-approved list, such as a pay phone from a restaurant, the security checking will be based upon the password allocated to this user, or the speaker verification mechanism previously described. The password will be a combination of numerical and alphanumerical characters also used when accessing the system from a PC via the Internet.

Dialogs are to be provided to facilitate error correction and validation of the accuracy of any information that is received. In cases where speech recognition is not yielding accurate results, the touch-tone entry of information is supported. In fact, except for the voiceprint match, all information can also be entered via touch-tone.

Capability is also present for the patient's physician to have access to the system both via the Internet as well as over the telephone. From a security stand point the physician will have a special access mechanism, with his own password, and will only have access to the information related to his or her specific patients. The physician can set the parameters for the patient, can leave messages (alerts) for the patient, and monitor the progress of the patient. The physician or a physician assistant can also be connected for a personal dialog with the patient through a switch not shown in the diagram. In this case, the “on-call” physician will be connected to the system through the Internet, and the patient last records, as well as his/her personal parameters, will be automatically displayed for the physician. Specific grammars for use in the speech recognition as well as specific dialogs are built to facilitate user friendly interaction. They take the form of <* <food> * <amount> *>. <food>=<steak|spinach|ice cream|. . . >for the general case in diet management. For diabetes monitoring only, it can be left blank. <amount>=<digits>|<digits>|<digits> where <digits>=<0|1|2|3|4|5|6|7|8|9>. These grammars can be extended so a person could say something like “I ate a 16 oz steak and a cup of creamed spinach”. The grammars are intended to “word spot” the amount of “16 oz” and “a cup” and the food group of “steak” and “creamed spinach”. The symbol * represents utterances to be ignored in the word spot mode. Confirmation dialogs are also specified to ensure accuracy and support user-friendly conditions such as recognizing <yes>=<that's correct|yes|OK|all right>. In all cases, we are also supporting input via touch-tone even though for word lists of food groups this could be cumbersome.

Attached are some sample computer programs, which show the collection of the relevant information from the patient and the physician. These outputs are web enabled and will be telephony enabled. Extensions will be for the patient to enter the specific food and portion size and for the program to determine the number of carbohydrates. With speech recognition, the person will say the food to be eaten and the portion size.

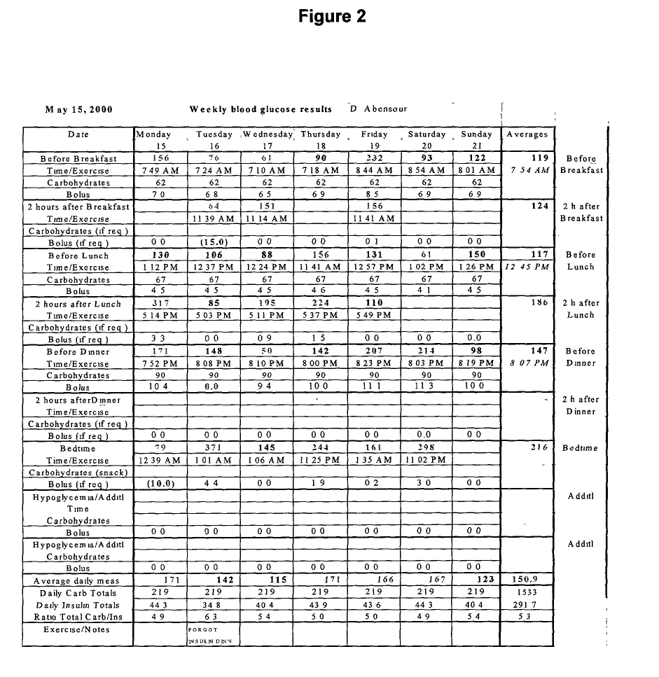

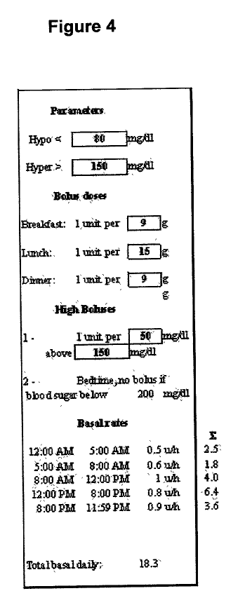

An example of some of he patient parameters is shown on FIG. 4 while a table output is shown on FIG. 2. Colors are used to tell the patient that his results are in the normal range, below or above the normal range. High blood sugar level is displayed in red, low blood sugar is displayed in green and blood sugar in the patient normal range is displayed in black. The same mechanisms and conventions are applied to the computed average values and trends.

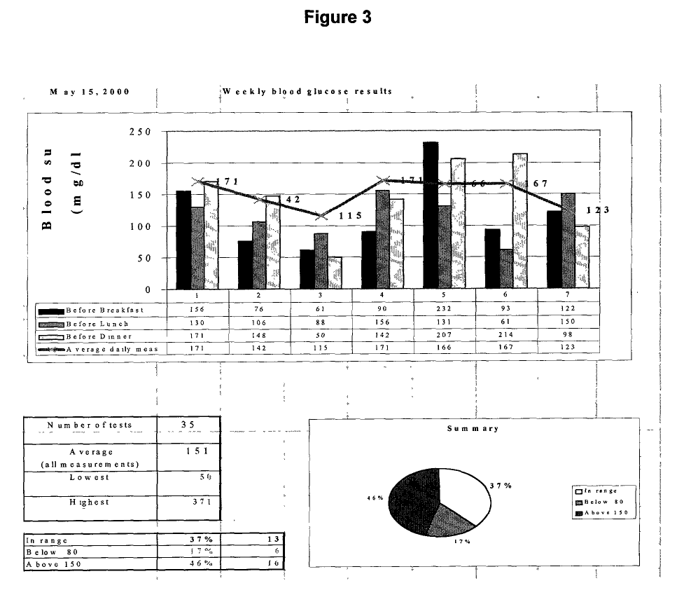

FIG. 3 depicts the tracking of the numbers and some additional statistics.

FIGS. 2, 3, AND 4 are only indicative of the results and of the parameters, which will be produced by the system in the diabetes management mode, for example a grouping of the results over a period longer than a week (a month or a quarter) will be provided. The daily results will be grouped into at least four categories:

1. Before breakfast

2. Before lunch

3. Before dinner

4. Bedtime

For each category, an output method showing the average, the standard deviation, the highest and the lowest value and the number of test results are provided. Other trends and statistical analysis are also provided for interpretation by the physician.

The above technologies and methods are also being included in a novel web site, which will be accessible to physicians and diabetic patients. This web site will also include chat rooms and sponsor web broadcasts on topics of interest.

The web site as well as the IVR system allows the patient to leave specific comments for a physician and the physician to leave specific comments for the patient. These comments can be an alert whenever the patient accesses the system via either the IVR or the web. Further, in all cases, all recommendations by DMS are advisory only and the patient is instructed that he can be connected to a physician IMMEDIATELY by entering a code or via speech recognition. Whenever the patient makes a blood test result input to the system, it is checked by the system against a range of normal values customized for this patient by the physician and part of the patient records as personal parameters. These values may vary with the timing of the test (for example a different range may be inputted by the physician for tests before a meal and during the night or after a physical exercise.) In all cases the system will repeat its understanding of the value(s) entered and will continue the processing only after the confirmation by the patient. However, if the system finds these values out of range, it will issue a warning describing the potential consequences, and if these values are way out of range, it will offer an immediate connection to a physician.

On a weekly basis the system will perform a computation of an index representing its synthesis of the patient health, with respect to diabetes, based on the blood tests results entered. This index will only have an indicational value. It will simulate the variation of hemoglobin A1C for the patient.

To be trained with the system utilization a set of high quality video examples are provided on the DMS web site. The patient can have access to those directly or at the physician's office.

Method

In practicing the invention, the following method may be used. The method includes the combination of an Internet site for insulin/glucose monitoring and advising via the web with similar interaction by telephony enabling web pages. The methods of this invention permit a person to enter and track the blood glucose levels, insulin injections, physician parameters, etc.. These methods are currently not available via a web interaction or via telephony and employing speech recognition. The method makes use of speech recognition, speech verification, telephony concepts (such as callerid recognition), calls for alerts, etc. are all features aimed at making the monitoring process and the recommended dosage accessible from any telephone. The methods identified are also relevant to the new class of phones that exploit WAP (wireless application protocol). Text-to-speech method is used for selected output. In addition, the methods indicated in this patent can be incorporated into stand-alone portable devices as well as monitoring devices. This opens the whole class of portable appliances. These methods are also applicable to general diet management. The method includes the steps of:

the physician entering the personal parameters of the patient into the system through the physician access means such as hypoglycemia and hyperglycemia levels, unit of insulin to be injected per x grams of carbohydrates before each of the principal meals; the patient entering his blood sugar test results and his projected carbohydrates intake into the system through the patient access means; the system ascertaining whether the patient is the legitimate patient referenced in the database; the system recommending a specific amount of medication and storing all the above data in the database; the system creating results such as several types of tables, graphs, trends and statistical analysis of the patient data; the physician or the patient or other authorized person obtaining these results on demand through a computer terminal.

We claim as our invention:

1. A computer system for ongoing monitoring and providing medication dosage recommendation to diabetic patients, comprising:
a database for storing patient data;
patient means of database access comprising one of web access, touch tone telephone access and speech recognition access;
a server;
a first set of programs contained within said server for processing the patient data and interfacing said patient means of data base access;
a computer terminal connected to the server through the World Wide Web containing said set of programs including the specific interface to the system for a patient's physician to enter patient specific parameters relevant to compute one of the insulin and other medication dosage;
a second set of programs contained within said server for diabetic management for interface by a patient and the patient physician by said patient means of database access;
and the second set of programs to be used to enter the current blood glucose, the planned intake of carbohydrates, and to generate a recommendation of one of a dosage of diabetic medication and a quantity of glucose for intake.
